(19) United States
(12) Patent Application Publication
(10) Pub. No.: US 2011/0130065 A1
(43) Pub. Date: Jun. 2, 2011

(54) METHOD FOR ADHERING LIGHT-TRANSMISSIVE SUBSTRATES AND METHOD FOR PRODUCING DISPLAY

(75) Inventors: Tomokazu Andoh, Yokohama-shi (JP); Tomoyuki Tamura, Yokohama-shi (JP); Shintarou Akiba, Isehara-shi (JP); Haruo Tomono, Machida-shi (JP); Kazuya Morohashi, Tokyo (JP)

(73) Assignee: CANON KABUSHIKI KAISHA, Tokyo (JP)

(21) Appl. No.: 12/953,628

(22) Filed: Nov. 24, 2010

(30) Foreign Application Priority Data
Nov. 27, 2009 (JP) 2009-269584
Aug. 24, 2010 (JP) 2010-186989

(51) Int. Cl. H01J 9/00

(52) U.S. Cl. 445/24

(57) ABSTRACT

A method for producing a display is provided, the method comprising a step of adhering a light-transmissive substrate, wherein it is possible to suppress the occurrence of any bubble when the light-transmissive substrate is adhered to a display surface, even when the display surface is large-sized. A plurality of adhesive puddles 3 are formed in an area which is disposed on a first light-transmissive substrate 1 and which is opposed to an adhesive puddle 4 formed on a second light-transmissive substrate 2. The spacing distance between the first and second light-transmissive substrates 1, 2 is narrowed while allowing the first and second light-transmissive substrates 1, 2 to be opposed to one another, and a space between the both is filled with the adhesive.

### BACKGROUND OF THE INVENTION

1. Field of the Invention

The present invention relates to a method for adhering light-transmissive substrates and a method for producing a display, comprising a step of adhering a light-transmissive substrate onto a side of a display surface.

2. Description of the Related Art

In order to protect a display surface of a display, for example, from any external impact or shock, an arrangement has been hitherto known, wherein an optical filter, which uses a base member of tempered glass excellent in the shock resistance, is directly stuck or adhered to the display surface (Japanese Patent Application Laid-open No. 2005-22365). On the other hand, the following method is known as a method for adhering a light-transmissive substrate, which can be utilized to adhere an EL element substrate and a color filter substrate of an EL display and which makes it possible to perform the adhesion without generating bubbles. That is, a method is known, comprising preparing two substrates at least one of which is a light-transmissive substrate, allowing an adhesive (liquid curable resin) to fall and drop onto a substrate surface, bringing the both substrates in tight-contact with each other, and spreading out the adhesive between the both substrates to effect the adhesion (Japanese Patent Application Laid-open No. 2000-10506).

As disclosed in Japanese Patent Application Laid-open No. 2005-22365 described above, those disposed on the display surface side of the display are constructed such that another light-transmissive substrate such as the optical filter or the like is laminated or stuck to the light-transmissive substrate which constitutes the wall surface disposed on the display surface side of a main body thereof. On the other hand, as the display is progressively large-sized in recent years, the respective light-transmissive substrates, which constitute those disposed on the display surface side of the display, are large-sized as well. In the case of the method disclosed in Japanese Patent Application Laid-open No. 2000-10506 described above, the adhesive is applied as small falling droplets, wherein there is a certain limitation as a matter of course in relation to the range in which the adhesive can be spread out. Therefore, in the case of the method described in Japanese Patent Application Laid-open No. 2000-10506, it is difficult to adhere a large-sized light-transmissive substrate without generating bubbles.

### SUMMARY OF THE INVENTION

The present invention provides the method for adhering the light-transmissive substrate which makes it possible to suppress the occurrence of any bubble even when the size of the light-transmissive substrate is large. Further, the present invention provides the method for producing the display comprising the step of adhering.

The present invention in its first aspect provides a method for adhering light-transmissive substrates, comprising:

a step of applying an adhesive to a first light-transmissive substrate to form adhesive puddles on the first light-transmissive substrate;

a step of applying the adhesive to a second light-transmissive substrate to form an adhesive puddle or adhesive puddles on the second light-transmissive substrate;

a step of arranging the first light-transmissive substrate and the second light-transmissive substrate while allowing a surface of the first light-transmissive substrate formed with the adhesive puddles to be directed downwardly so that the adhesive puddles, which are formed on the first light-transmissive substrate, are opposed to the adhesive puddle or adhesive puddles which is/are formed on the second light-transmissive substrate; and

a step of allowing the first light-transmissive substrate and the second light-transmissive substrate to approach to one another so that a space between the first light-transmissive substrate and the second light-transmissive substrate is filled with the adhesive applied to the first light-transmissive substrate and the second light-transmissive substrate, wherein:

a plurality of the adhesive puddles are formed on the first light-transmissive substrate in an area which is disposed on the first light-transmissive substrate and which is opposed to the adhesive puddle formed on the second light-transmissive substrate.

The present invention in its second aspect provides a method for producing a display comprising a display body and a light-transmissive substrate adhered to an outer surface disposed on a display surface of the display body, the method comprising:

a step of applying an adhesive to the outer surface disposed on the display surface of the display body to form an adhesive puddle or adhesive puddles on the outer surface disposed on the display surface of the display body;

a step of applying the adhesive to one surface of the light-transmissive substrate to form adhesive puddles on the light-transmissive substrate;

a step of arranging the display body and the light-transmissive substrate while allowing the surface of the light-transmissive substrate formed with the adhesive puddles to be directed downwardly so that the adhesive puddles, which are formed on the light-transmissive substrate, are opposed to the adhesive puddle or adhesive puddles which is/are formed on the outer surface disposed on the display surface of the display body; and

a step of allowing the display body and the light-transmissive substrate to approach to one another so that a space between the light-transmissive substrate and the outer surface disposed on the display surface of the display body is filled with the adhesive applied to the light-transmissive substrate and the outer surface disposed on the display surface of the display body, wherein:

a plurality of the adhesive puddles are formed on the light-transmissive substrate in an area which is disposed on the light-transmissive substrate and which is opposed to the adhesive puddle formed on the outer surface disposed on the display surface of the display body.

Further features of the present invention will become apparent from the following description of exemplary embodiments with reference to the attached drawings.

### BRIEF DESCRIPTION OF THE DRAWINGS

FIG. 1 shows schematic plan views illustrating a state in which adhesive puddles are formed on two light-transmissive substrates respectively.

FIG. 2 shows a schematic arrangement of an apparatus to be used to adhere the two light-transmissive substrates.

FIG. 3 shows steps in an embodiment of the present invention.

FIG. 4 shows steps in the embodiment, of the present invention continued from FIG. 3.

FIG. 5 explains the entrainment or catching of bubbles during the adhesion of two light-transmissive substrates.

FIG. 6 explains the entrainment or catching of bubbles during the adhesion of the two light-transmissive substrates.

FIG. 7 shows another embodiment of the present invention.

FIG. 8 shows schematic sectional views to explain a display body and light-transmissive substrates.

### DESCRIPTION OF THE EMBODIMENTS

The present invention provides a method for producing a display comprising a display body and a light-transmissive substrate adhered to an outer surface disposed on a display surface of the display body, the method comprising:

a step of applying an adhesive to the outer surface disposed on the display surface of the display body to form an adhesive puddle or adhesive puddles on the outer surface disposed on the display surface of the display body;

a step of applying the adhesive to one surface of the light-transmissive substrate to form adhesive puddles on the light-transmissive substrate;

a step of arranging the display body and the light-transmissive substrate while allowing the surface of the light-transmissive substrate formed with the adhesive puddles to be directed downwardly so that the adhesive puddles, which are formed on the light-transmissive substrate, are opposed to the adhesive puddle or adhesive puddles which is/are formed on the outer surface disposed on the display surface of the display body; and

a step of allowing the display body and the light-transmissive substrate to approach to one another so that a space between the light-transmissive substrate and the outer surface disposed on the display surface of the display body is filled with the adhesive applied to the light-transmissive substrate and the outer surface disposed on the display surface of the display body, wherein:

a plurality of the adhesive puddles are formed on the light-transmissive substrate in an area which is disposed on the light-transmissive substrate and which is opposed to the adhesive puddle formed on the outer surface disposed on the display surface of the display body.

The method for producing a display described above is based on the following invention. That is, a method for adhering light-transmissive substrates, comprising:

a step of applying an adhesive to a first light-transmissive substrate to form adhesive puddles on the first light-transmissive substrate;

a step of applying the adhesive to a second light-transmissive substrate to form an adhesive puddle or adhesive puddles on the second light-transmissive substrate;

a step of arranging the first light-transmissive substrate and the second light-transmissive substrate while allowing a surface of the first light-transmissive substrate formed with the adhesive puddles to be directed downwardly so that the adhesive puddles, which are formed on the first light-transmissive substrate, are opposed to the adhesive puddle or adhesive puddles which is/are formed on the second light-transmissive substrate; and

a step of allowing the first light-transmissive substrate and the second light-transmissive substrate to approach to one another so that a space between the first light-transmissive substrate and the second light-transmissive substrate is filled with the adhesive applied to the first light-transmissive substrate and the second light-transmissive substrate, wherein:

a plurality of the adhesive puddles are formed on the first light-transmissive substrate in an area which is disposed on the first light-transmissive substrate and which is opposed to the adhesive puddle formed on the second light-transmissive substrate.

According to the method for producing the display of the present invention, it is possible to provide the method for producing the display, comprising the step of adhering the light-transmissive substrate, which makes it possible to suppress the occurrence of any bubble even when the display surface is large and the size of the light-transmissive substrate to be laminated thereto is large. Further, according to the method for adhering the light-transmissive substrates of the present invention, the large-sized light-transmissive substrates can be laminated to one another while suppressing the occurrence of bubbles.

When the light-transmissive substrates are adhered to one another by using the adhesive, it is necessary that the amount of application of the adhesive should be progressively increased as the sizes of the light-transmissive substrate are increased, in order to diffuse the adhesive to the entire surfaces of the substrates. However, if a large amount of the adhesive is simply applied onto one substrate to laminate the substrates to one another, the bubbles remain between the two substrates in some cases. The bubbles disturb the light-transmissive performance of the substrate, and the bubbles may consequently cause the deterioration of the quality or grade of an image when the substrates are used to produce the display. The problem as described above arises more frequently as the sizes of the both substrates are more increased.

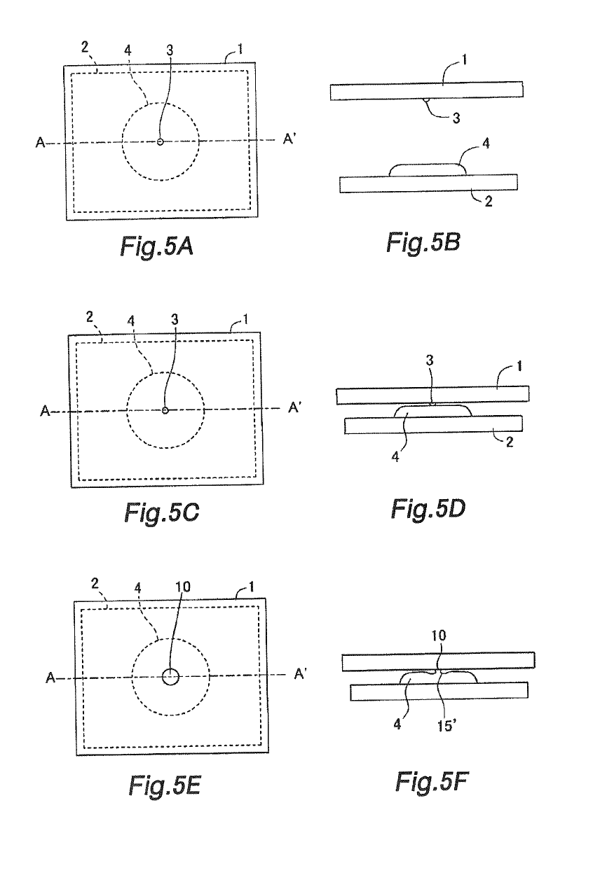

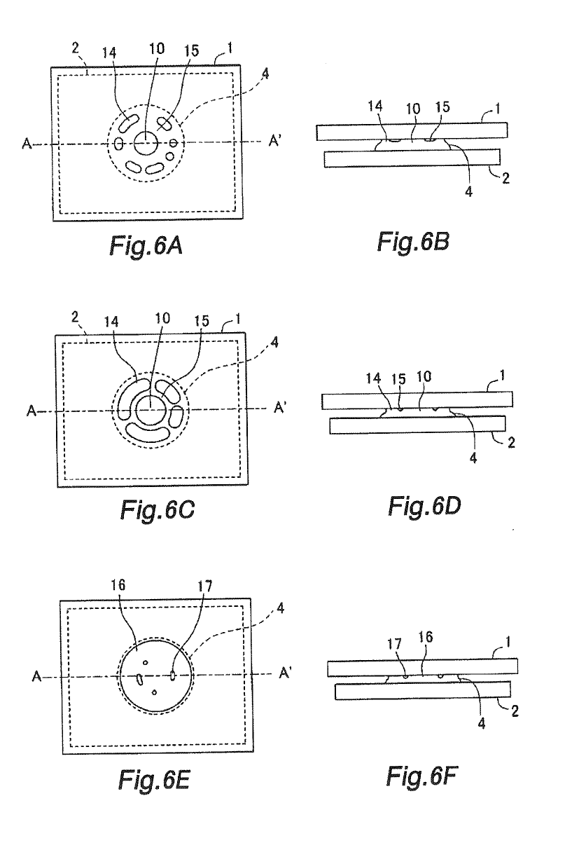

In order to elucidate the cause of this problem, the present inventors have investigated the cause of the remaining bubbles in detail. An explanation will be made with reference to FIGS. 5 and 6. FIGS. 5A, 5C, and 5E and FIGS. 6A, 6C, and 6E show plan views illustrating respective adhering steps, and FIGS. 5B, 5D, and 5F and FIGS. 6B, 6D, and 6F show sectional views taken along lines A-A′ shown in FIGS. 5A, 5C, and 5E and FIGS. 6A, 6C, and 6E respectively. In the drawings, reference numeral 1 indicates a first light-transmissive substrate (hereinafter referred to as “first substrate”) such as a glass plate or the like, reference numeral 2 indicates a second light-transmissive substrate (hereinafter referred to as “second substrate”) such as a glass plate or the like as well, and reference numerals 3, 4 indicate adhesive puddles formed by applying an adhesive to the first substrate 1 and the second substrate 2 respectively. The term “adhesive puddle” herein refers to a state in which the adhesive stays while being bulged from the sticking surface in accordance with the surface tension when the adhesive is stuck to the surface which is directed upwardly. The term “adhesive puddle” also refers to a state in which the adhesive stays while having a surface curved to protrude downwardly on account of the surface tension and the self-weight when the adhesive is stuck to the surface which is directed downwardly.

The adhesive puddle 4 is formed by applying the adhesive to a central portion on the second substrate 2. The adhesive puddle 4 is formed on the second substrate 2 with the adhesive in such an amount that the adhesive can be charged between the first and second substrates 1, 2 while developing and extending the adhesive between the both by mutually pressing the first and second substrates 1, 2. On the other hand, a small amount of the adhesive is applied onto the first substrate 1 in an area which is disposed on the first substrate 1 and which is opposed to the adhesive puddle 4 formed on the second substrate 2 to form the adhesive puddle 3 which has an areal size smaller than that of the adhesive puddle 4. The adhesive puddles 3, 4 can be easily formed with predetermined amounts of the adhesive by means of the downward pouring or the dropping of the adhesive. In this state, the surface of the first substrate 1, on which the adhesive puddle 3 is formed, is directed downwardly, and the first substrate 1 and the second substrate 2 are opposed to one another in the vertical direction so that the adhesive puddle 3 and the adhesive puddle 4 are opposed to one another (FIGS. 5A and 5B). The first substrate 1 and the second substrate 2 are allowed to approach to one another. The adhesive, which has been applied to the first substrate 1 and the second substrate 2, is interposed between the first substrate 1 and the second substrate 2, and the adhesive is allowed to develop and extend so that the space between the both is filled with the adhesive.

At first, the first substrate 1 and the second substrate 2 are allowed to approach to one another, and the adhesive puddle 3 formed on the first substrate 1 and the adhesive puddle 4 formed on the second substrate 2 are brought in contact with each other (FIGS. 5C and 5D). Accordingly, the adhesive puddles 3, 4 are connected to one another, and an inter-adhesive puddle combined portion 10 is formed. When the inter-adhesive puddle combined portion 10 is formed, the adhesive puddle 4, which is disposed on the second substrate 2, is attracted toward the first substrate 1 in accordance with the surface tension. As the inter-adhesive puddle combined portion 10 is spread or expanded, a recess 15′ is formed on the upper surface of the adhesive puddle 4 on the second substrate 2 around the inter-adhesive puddle combined portion 10 (FIGS. 5E and 5F) to give a state in which minute wavinesses are generated on the surface of the adhesive puddle 4.

When the distance between the first substrate 1 and the second substrate 2 is further narrowed, then protrusions of the minute wavinesses (outside of the recess 15′ described above), which are disposed on the upper surface of the adhesive puddle 4, are brought in contact with the surface of the first substrate 1, and adhesive contacting sticking portions 14 are formed (FIGS. 6A and 6B). In this situation, a void 15, which results from the presence of the recess 15′, intervenes between the firstly formed inter-adhesive puddle combined portion 10 and the newly formed adhesive contacting sticking portions 14. When the distance between the first and second substrates 1, 2 is progressively narrowed, then the adhesive contacting sticking portions 14 are gradually spread or expanded, the adjoining adhesive contacting sticking portions 14 are brought in contact with each other, and they are progressively integrated into one (FIGS. 6C and 6D). The void 15, which is formed between the inter-adhesive puddle combined portion 10 and the adhesive contacting sticking portions 14, is gradually extruded to the surrounding. However, the adhesive contacting sticking portions 14 are finally connected to one another and integrated into one while allowing bubbles 17 to remain between the adhesive contacting sticking portions 14 and the inter-adhesive puddle combined portion 10 which is disposed at the center (FIGS. 6E and 6F). When the spacing distance between the first and second substrates 1, 2 is further narrowed in this state, then an adhesive interposing area 16, in which the inter-adhesive puddle combined portion 10 and the adhesive contacting sticking portions 14 are integrated into one, is spread or expanded, but the bubbles 17, which have been once contained therein, remain as they are without being extruded.

By the way, it is considered that the position, at which the minute waviness is generated as described above, relates to the distance from the inter-adhesive puddle combined portion 10 to the end portion of the adhesive puddle 4. When the sizes of the first and second substrates 1, 2 are increased, the diameter of the adhesive puddle 4 is increased in order to charge the adhesive between the both. As the distance described above is increased in accordance with the increase in the diameter of the adhesive puddle 4, the minute wavinesses tend to arise. When the spacing distance between the first and second substrates 1, 2 is narrowed, the protrusions of the minute wavinesses are brought in contact with the first substrate 1. As a result, the adhesive contacting sticking portions 19 are formed outside the inter-adhesive puddle combined portion 10, and the bubbles consequently remain therebetween.

In this arrangement, if the area of the adhesive puddle 3 is widened to increase the diameter of the inter-adhesive puddle combined portion 10 by increasing the amount of the adhesive puddle 3 disposed on the side of the first substrate 1, it is possible to narrow the distance from the inter-adhesive puddle combined portion 10 to the end portion of the adhesive puddle 4 disposed on the second substrate 2. However, in this procedure, the first substrate 1 is opposed to the second substrate 2 while directing the adhesive puddle 3 downwardly. Therefore, if the amount of application of the adhesive to the first substrate 1 is increased, it is feared that the adhesive, which has been applied to the first substrate 1, may flow or fall onto the second substrate 2 when the first substrate 1 is reversed.

The present inventors have found out the fact that the effect, which is the same as or equivalent to the effect obtained by increasing the diameter of the inter-adhesive puddle combined portion 10 described above, is obtained by forming a plurality of adhesive puddles 3 on the first substrate 1. Thus, the present invention has been completed. That is, when the plurality of adhesive puddles 3 are formed on the first substrate 1, it is possible to form a plurality of inter-adhesive puddle combined portions by preferentially bringing the plurality of adhesive puddles 3 and the adhesive puddle 4 in contact with each other before the protrusions of the minute wavinesses described above are brought in contact with the first substrate 1. Accordingly, the inter-adhesive puddle combined portions, which are formed by the contact between the adhesive puddles 3 and the adhesive puddle 4, can be formed at positions at which the distances to the end portions of the adhesive puddle 4 on the second substrate 2 are small. Therefore, the adhesive contacting sticking portions 14, which would be otherwise formed by the contact between the first substrate 1 and the protrusions of the minute wavinesses, are not generated. The entrainment or catching of bubbles is suppressed.

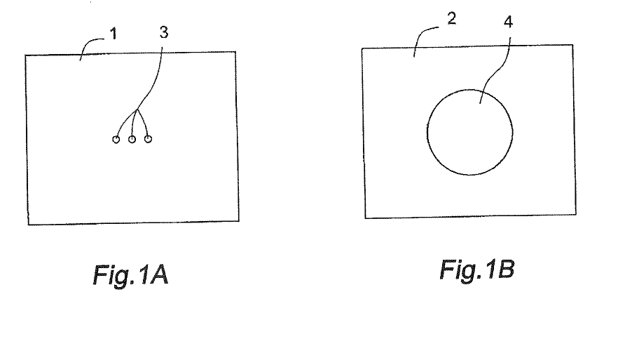

An adhering method according to the present invention will be explained below with reference to FIGS. 1 to 4 as exemplified by an embodiment. The members, which are the same as those shown in FIGS. 5 and 6, are designated by the same reference numerals.

FIGS. 1A and 1B show a schematic plan view illustrating a surface for forming adhesive puddles 3 on a first substrate 1 (first light-transmissive substrate) and a schematic plan view illustrating a surface for forming an adhesive puddle 4 on a second substrate 2 (second light-transmissive substrate) respectively according to the embodiment of the present invention. The first substrate 1 and the second substrate 2 are composed of, for example, glass, and the adhesive puddles 3, 4 are formed by using the same adhesive. Those usable as the adhesive to be applied include, for example, thermosetting type adhesives, cold setting type adhesives, two-part reaction type adhesives, and UV-curable type adhesives. It is preferable that the viscosity of the adhesive is selected from those within a range of 0.1 Pa's to 10 Pa's at 25° C. A dispenser is used to apply the adhesive.

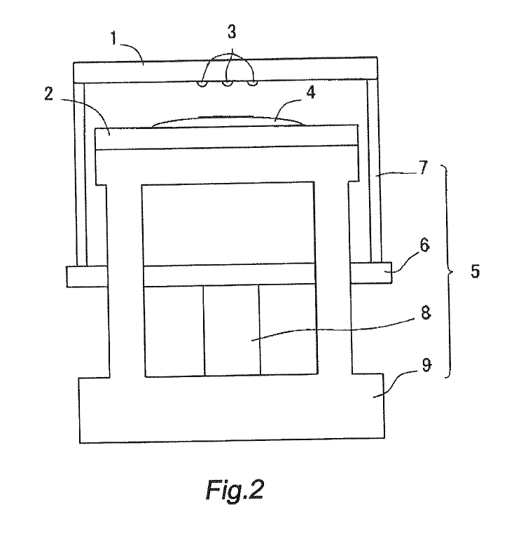

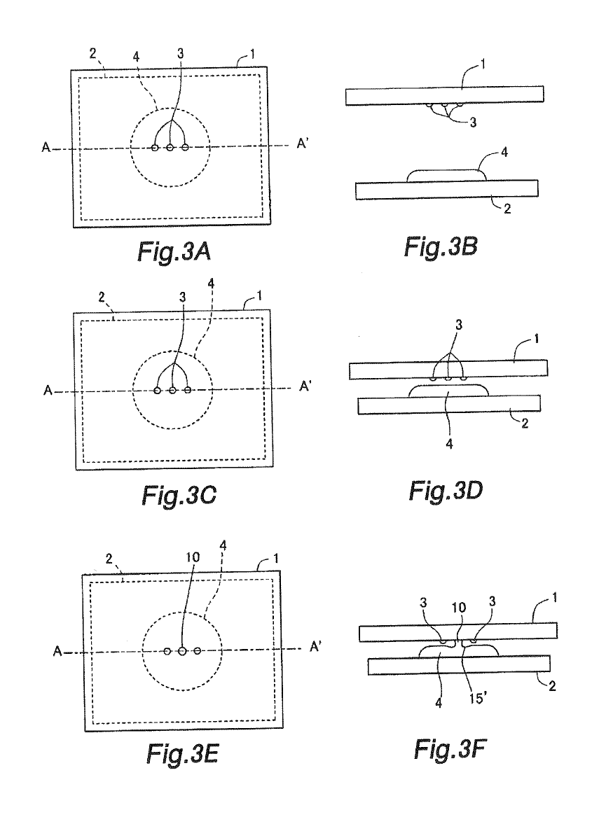

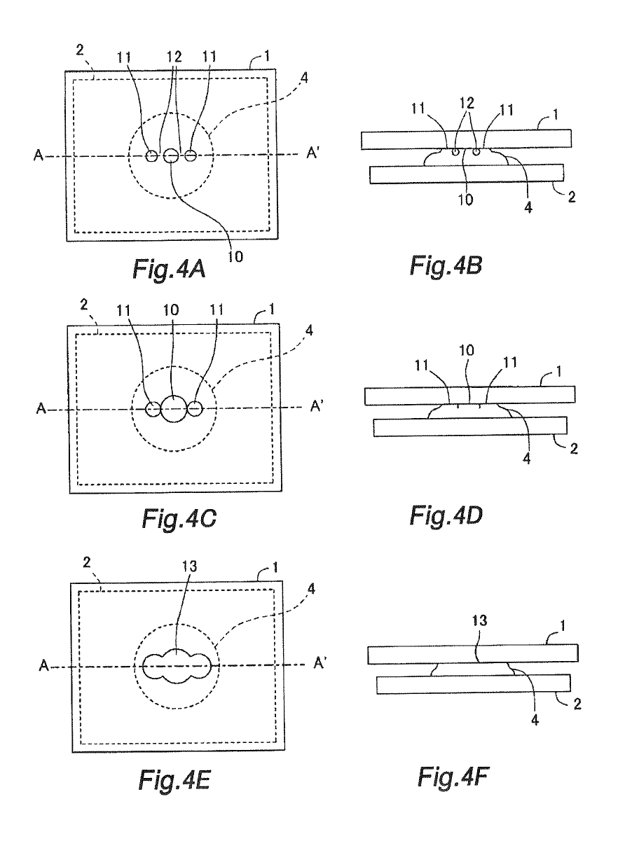

FIG. 2 shows a schematic arrangement of an apparatus to be used for adhering the two light-transmissive substrates in the embodiment of the present invention. FIGS. 3 and 4 show a series of steps in the embodiment of the present invention, wherein FIGS. 3A, 3C, and 3E and FIGS. 4A, 4C, and 4E show plan views, and FIGS. 3B, 3D, and 3F and FIGS. 4B, 4D, and 4F show sectional views taken along lines A-A′ shown in FIGS. 3A, 3C, and 3E and FIGS. 4A, 4C, and 4E respectively.

At first, the plurality of adhesive puddles 3 are formed on the first substrate 1 in an area which is disposed on the first substrate 1 and which is opposed to the adhesive puddle 4 formed on the second substrate 2. In this embodiment, as shown in FIGS. 1A and 1B and FIGS. 3A and 3B, the adhesive is applied at three positions on the first substrate 1 and at one position on the second substrate 2 respectively. The three adhesive puddles 3 are formed on the first substrate 1, and the one adhesive puddle 4 is formed on the second substrate 2. In this situation, the adhesive puddle 4, which is spread or expanded in a planar form, is formed on the second substrate 2 with the adhesive in such an amount that the adhesive can develop and extend between the first and second substrates 1, 2 so that the adhesive can be charged between the both by mutually pressing the first and second substrates 1, 2. The adhesive, which is applied to the first substrate 1, has the amount which is smaller than the amount of the adhesive which is applied to the second substrate 2, and the adhesive puddles 3 are formed thereby. As described above, the adhesive puddles 3, 4 can be easily formed by using the predetermined amounts of the adhesive by means of the downward pouring or the dropping of the adhesive. The plurality of adhesive puddles 3, which are formed on the first substrate 1, have the totalized areal size smaller than the areal size of the adhesive puddle 4 which is formed on the second substrate 2. The three adhesive puddles 3, which are formed on the first substrate 1, are formed in the area which is disposed on the first substrate 1 and which is opposed to the adhesive puddle 4 formed on the second substrate 2.

In this embodiment, the plurality of adhesive puddles 3 are formed on the first substrate 1. However, the number and the arrangement of the adhesive puddles 3 to be formed are not specifically limited. Preferably, as shown in FIG. 1, three or more adhesive puddles 3 are formed on a straight line including the central portion of the adhesive puddle 4 which is formed on the second substrate 2.

Subsequently, the first substrate 1 and the second substrate 2 are arranged while the surface of the first substrate 1, on which the adhesive puddles 3 are formed, is directed downwardly so that the adhesive puddles 3, which are formed on the first substrate 1, are opposed to the adhesive puddle 4 which is formed on the second substrate 2.

FIG. 2 shows a state in which the first substrate 1 is disposed opposingly over or above the second substrate 2 by using a lifting jig 5. Reference numeral 6 indicates a lifting stage which is fixed to a Z stage 8. Further, lifting pins 7 are fixed to the lifting stage 6. The lifting pins 7 can be moved upwardly and downwardly by the aid of the lifting stage 6 by moving the Z stage 8 upwardly and downwardly. Reference numeral 9 indicates a machine base on which the second substrate 2 is installed, while the Z stage 8 is fixed thereto. The lifting jig 5 is constructed by the lifting stage 6, the lifting pins 7, the Z stage 8, and the machine base 9.

With reference to FIG. 2, the second substrate 2 is installed on the machine base 9 while upwardly directing the adhesive puddle 4 formed on the second substrate 2. Further, the first substrate 1 is installed on the lifting pins 7 while downwardly directing the adhesive puddles 3 formed on the first substrate 1 (FIGS. 3A and 3B). Subsequently, the first substrate 1 and the second substrate 2 are allowed to approach to one another (FIGS. 3C and 3D). The Z stage 8 is moved downwardly at a predetermined velocity, and the position of the first substrate 1 is lowered until the adhesive puddles 3 and the adhesive puddle 4 are brought in contact with each other. In this situation, the lower ends of the adhesive puddles 3 are parts of spherical surfaces, and the surface of the adhesive puddle 4 is substantially planar. Therefore, the point-to-point contact is provided between the spherical surfaces and the flat surface, and no bubble is caught or entrained upon the contact. Further, an inter-adhesive puddle combined portion 10 is formed in accordance with the contact between the adhesive puddle 3 and the adhesive puddle 4. At this point in time, the adhesive puddle 4 is attracted toward the first substrate 1 in accordance with the surface tension, and the inter-adhesive puddle combined portion 10 is expanded or spread. A recess 15′ is formed on the adhesive puddle 4 disposed therearound (FIGS. 3E and 3F).

Subsequently, the Z stage 8 is moved downwardly at a predetermined velocity, and the distance between the first substrate 1 and the second substrate 2 is gradually narrowed. Accordingly, the inter-adhesive puddle combined portion 10 is further expanded, and the adhesive puddle 4 disposed on the side of the second substrate 2 is brought in contact with the uncombined adhesive puddles 3 disposed on the side of the first substrate 1 to form new inter-adhesive puddle combined portions 11. Air-gaps 12 are formed between the inter-adhesive puddle combined portions 10, 11 (FIGS. 4A and 4B).

When the Z stage 8 is further moved downwardly to narrow the spacing distance between the first substrate 1 and the second substrate 2, then the inter-adhesive puddle combined portions 10, 11 are further expanded, the voids 12 are decreased, and the inter-adhesive puddle combined portions 10, 11 are brought in contact with each other (FIGS. 4C and 4D). When the Z stage 8 is further moved downwardly as it is to further narrow the spacing distance between the first substrate 1 and the second substrate 2, the inter-adhesive puddle combined portions 10, 11, which have been brought in contact with each other, are integrated into one which is further expanded progressively while extruding the voids 12 to the outside (FIGS. 4E and 4F).

The Z stage 8 is further moved downwardly to expand the adhesive combined portion 13 in which the inter-adhesive puddle combined portions 10, 11 are integrated into one. The lifting pins 7 are sufficiently lowered, and they are separated from the first substrate 1. The combined portion 13 of the adhesive is pressed by the self-weight of the first substrate 1, and thus the combined portion 13 of the adhesive is further expanded. The air, which remains between the first substrate 1 and the second substrate 2, is extruded to the outside by the expanding adhesive combined portion 13. Therefore, the space between the first substrate 1 and the second substrate 2 is filled with the adhesive without generating any bubble.

In the embodiment described above, the puddle disposed at the central portion, which is included in the three adhesive puddles 3 formed on the first substrate 1, is firstly brought in contact with the adhesive puddle 4 formed on the second substrate 2. However, the same or equivalent function and effect are obtained even when any one of the three adhesive puddles 3 is brought in contact with the adhesive puddle 4 earlier.

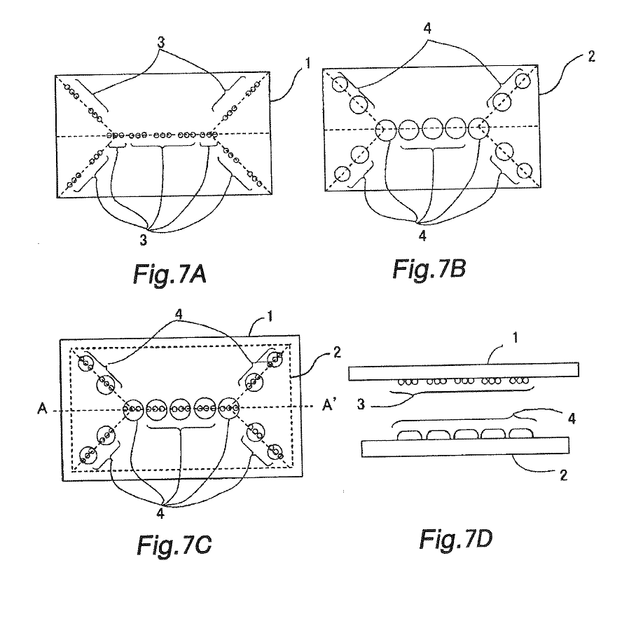

Next, another embodiment will be explained on the basis of FIG. 7. FIGS. 7A and 7B show a schematic plan view illustrating a surface for forming adhesive puddles 3 on a first substrate 1 and a schematic plan view illustrating a surface for forming adhesive puddles 4 on a second substrate 2 respectively according to the another embodiment of the present invention. In FIG. 7, FIG. 7C shows a plan view illustrating a state in which the first substrate 1 and the second substrate 2 are arranged while confronting the surfaces thereof for forming the adhesive puddles 3, 4 with each other. FIG. 7D shows a sectional view taken along a line A-A′ shown in FIG. 7C. In FIG. 7, the members, which are the same as or equivalent to those shown in FIGS. 5 and 6, are designated by the same reference numerals. In the embodiment shown in FIG. 7, the plurality of adhesive puddles 4 are formed on the second substrate 2, and the plurality of adhesive puddles 3 are formed at each of the positions on the first substrate 1 opposed to the respective adhesive puddles 4. In other words, a plurality of sets are formed in this method, wherein one set includes the adhesive puddles 3, 4 referred to in the embodiment explained with reference to FIGS. 1 to 4. Except for this feature, the another embodiment is the same as or equivalent to the embodiment described above. The plurality of adhesive puddles 4 are formed on the second substrate 2. However, the number and the arrangement of the adhesive puddles 4 to be formed are not specifically limited. When the second substrate 2 is a rectangle, it is desirable that the adhesive puddles 4 are preferably formed on a′ line for connecting two points of intersection at which bisectors of interior angles of respective corners and a straight line for connecting centers of both short sides intersect and on line segments of the bisectors which range from the corners to the points of intersection. The adhesive puddles 4, which are formed on the two points of intersection at which the bisectors of the interior angles of the respective corners and the line for connecting the centers of the both short sides intersect and on the line which connects the two points of intersection, mainly fill the space between the central portions of the first substrate 1 and the second substrate 2. It is preferable that the amount of the adhesive of the adhesive puddles 4 disposed on the two points of intersection and the amount of the adhesive and the number of the adhesive puddles 4 formed on the line for connecting the two points of intersection are adjusted to such amounts and such a number that the space between the central portions of the first substrate 1 and the second substrate 2 is appropriately filled therewith. It is desirable that the larger the aspect ratio is, the larger the number of dropping droplets is to effect the adjustment. The adhesive puddles 4, which are formed on the line segments of the bisectors ranging from the corners to the points of intersections, mainly fill the space between the corner portions of the first substrate 1 and the second substrate 2. It is preferable that the amount of the adhesive and the number of the adhesive puddles 4 formed on the line segment of the bisector ranging from the corner to the point of intersection are adjusted to such an amount and such a number that the space between the corner portions of the first substrate 1 and the second substrate 2 is appropriately filled therewith. Accordingly, it is possible to adjust the expanding shape of the adhesive. Further, the distances, which range from the adhesive puddle 4 formed within the range of the bisector from the corner to the point of intersection to the two sides for forming the corner of the second substrate 2 in which the adhesive puddle 4 is formed, are approximately equal to one another. Therefore, when the adhesive, in which the expanding shape is adjusted, is expanded or spread uniformly or equivalently, it is possible to decrease the extruding amount of the adhesive from the second substrate 2.

When the method for adhering the light-transmissive substrates described above is applied to adhere a light-transmissive substrate to an outer surface disposed on a display surface of a display body, it is possible to suppress the occurrence of bubbles, even when the sizes of the display surface and the light-transmissive substrate are increased. Therefore, it is possible to produce a display which is excellent in the quality or grade of an image. The adhering method described above is appropriate to produce, for example, flat panel displays including, for example, electron beam display panels, liquid crystal display panels, EL display panels, and plasma display panels. However, the adhering method described above can be also used to produce cathode ray tube (CRT) displays. The display body concerning the present invention refers to a panel portion for constructing a screen in the case of the flat panel display or a CRT portion in the case of the CRT display.

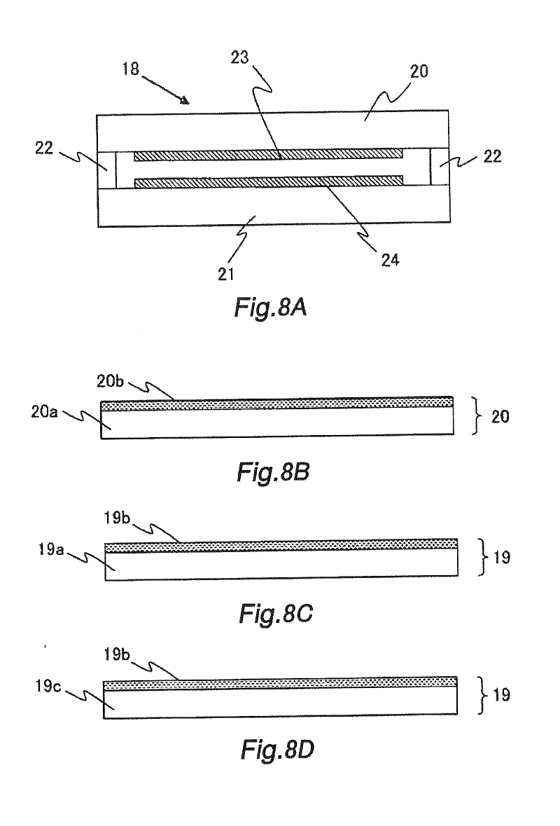

As shown in FIG. 8A, a display body 18 is provided with a display substrate 20 which constitutes the display surface side, a back surface substrate 21 which constitutes the back surface side, and a frame 22 which constitutes an airtight envelope together with the display substrate 20 and the back surface substrate 21. An image display means is arranged in the airtight envelope. The image display means includes, for example, a fluorescent substance 23 which is arranged on the side of the display substrate 20 and an electron source 24 which is arranged on the side of the back surface substrate 21, as exemplified by an electron beam display panel by way of example. Although not shown, the image display means includes, for example, a liquid crystal, transistors, electrodes and the like in the case of the liquid crystal display panel, EL elements and the like in the case of the EL display panel, or a fluorescent substance, a plasma-generating gas, electrodes and the like in the case of the plasma display panel.

As shown in FIG. 8B, the display substrate 20, which constitutes the display surface side of the display body 18, is an example of the light-transmissive substrate. The display substrate 20 is composed of a transparent glass 20a and a light-transmissive resin film 20b which is stuck to a surface thereof in some cases, or the display substrate 20 is composed of a transparent glass 20a singly in other cases. The light-transmissive resin film 20b is a resin film provided with, for example, the function to suppress the electrification, suppress the light reflection, and/or serve as a color filter. As shown in FIGS. 8C and 8D, a light-transmissive substrate 19 is composed of a transparent glass 19a or a transparent resin substrate 19c and a light-transmissive resin film 19b which is stuck to a surface thereof in some cases, or the light-transmissive substrate 19 is composed of a transparent glass 19a or a transparent resin substrate 19c singly in other cases. The light-transmissive resin film 19b is a resin film provided with, for example, the function to suppress the electrification, suppress the light reflection, and/or serve as a color filter. Usually, a film, which has the function different from that of the light-transmissive resin film 20b, is used as the light-transmissive resin film 19b, when the display substrate 20 of the display body 18 is provided with the light-transmissive resin film 20b. However, a film having the same type of the function may be also used as the light-transmissive resin film 19b. In view of the improvement in the shock resistance of the display body 18, it is preferable that the light-transmissive substrate 19 is composed of the transparent glass 19a or the transparent glass 19a and the light-transmissive resin film 19b stuck to the surface thereof.

The light-transmissive substrate 19 is adhered to the outer surface disposed on the display surface in the step of producing the display after the display body 18 is assembled. Therefore, in relation to the adhesion of the light-transmissive substrate 19 in the method for producing the display of the present invention, the second substrate 2 as shown in FIGS. 1 to 4 and 7 is replaced with the display body 18, and the first substrate 1 is replaced with the light-transmissive substrate 19 to be adhered to the outer surface disposed on the display surface thereof. Further, the same or equivalent situation is provided when the surface of the second substrate 2 for forming the adhesive puddle or puddles 4 is regarded as the outer surface disposed on the display surface.

### Example 1

Three types of substrates for 13 inches, 30 inches, and 50 inches, each of which was composed of soda lime plate glass having a thickness of 2.5 mm and an aspect ratio of 1.25, were prepared as the first and second substrates 1, 2 shown in FIGS. 1A and 1B, and they were washed with alcohol. The size of the first substrate 1 was diagonally larger than that of the second substrate 2 by 10 mm. Subsequently, an acrylic UV-curable resin (acrylic acid ester: 60% by mass, synthetic resin: 30% by mass, photoinitiator: 10% by mass, viscosity: 2 Pa·s, specific gravity: 1.0) was introduced into a syringe, and the acrylic UV-curable resin was deaerated with a deaerator. The centrifugal system or the vacuum deaeration was utilized for the deaeration. After that, the syringe was installed to a dispenser, and the adhesive was applied onto the first and second substrates 1, 2.

The amount of the adhesive was 0.05 ml for one position or portion in relation to the first substrate 1 having any one of the sizes, and the adhesive was applied by means of the dropping. However, the number of the adhesive puddles 3 formed thereby differed depending on the size. As for the first substrate 1 of 13 inches, the adhesive was applied to three portions including the central portion and two other portions to form three adhesive puddles 3 as shown in FIG. 1A. As for the first substrate 1 of 30 inches, the adhesive was applied to nine portions including the central portion and eight other portions to form nine adhesive puddles 3. As for the first substrate 1 of 50 inches, the adhesive was applied to thirteen portions including the central portion and twelve other portions to form thirteen adhesive puddles 3. The adhesive was applied to any one of the first substrates 1 described above at intervals or spacing distances of 40 mm at positions on a straight line passing through the center. The adhesive was applied onto the second substrate 2 at the central portion in an amount of 0.75 ml per 1 inch of the substrate size to form the adhesive puddle 4 as shown in FIG. 1B on the second substrate 2 having each of the sizes. The substrates 1, 2 were attached to the apparatus shown in FIG. 2. In this situation, the spacing distance between the first substrate 1 and the second substrate 2 was 5 mm.

The adhesive puddle 3 is the liquid. Therefore, the adhesive puddle 3 was expanded to have a diameter of 8 mm, it hung down by about 1 mm on account of the gravity, and the forward end was spherical. However, in the case of the amount applied in Example 1, the adhesive puddles 3 did not dribbled or fell in drops even when the first substrate 1 was arranged while the surface, on which the adhesive puddles 3 were formed, was placed on the lower side. On the other hand, the adhesive puddle 4 was expanded in a wet state to provide a diameter of 160 mm and a thickness of 0.5 mm in the case of 13 inches. The central portion was approximately in a state of flat surface (FIGS. 3A and 3B).

Subsequently, the Z stage 8 was moved downwardly at a velocity of 0.5 mm per second, and the first substrate 1 was lowered to a position at which the adhesive puddles 3 and the adhesive puddle 4 were brought in contact with each other (FIGS. 3C and 3D). In this situation, the lower ends of the adhesive puddles 3 were parts of the spherical surfaces, and the surface of the adhesive puddle 4 was substantially the flat surface. Therefore, the point-to-point contact was effected between the spherical surfaces and the flat surface, and any bubble was not caught upon the contact. An inter-adhesive puddle combined portion 10 was generated immediately after the contact between the adhesive puddles 3, 4. At this point in time, the adhesive puddle 4 was attracted toward the first substrate 1 in accordance with the surface tension. The inter-adhesive puddle combined portion 10 was expanded, and a recess 15′ was generated therearound (FIGS. 3E and 3F).

Subsequently, the Z stage 8 was moved downwardly at a velocity of 0.01 mm per second to gradually narrow the distance between the first substrate 1 and the second substrate 2. Accordingly, the inter-adhesive puddle combined portion 10, which was firstly formed, was further expanded, and the uncombined adhesive puddles 3, which were allowed to remain, were brought in contact with the adhesive puddle 4 to form new inter-adhesive puddle combined portions 11. As a result, voids 12 were formed between the adjoining inter-adhesive puddle combined portions 10, 11 (FIGS. 4A and 43).

When the Z stage 8 was further moved downwardly at a velocity of 0.01 mm per second to progressively narrow the spacing distance between the first and second substrates 1, 2, then the inter-adhesive puddle combined portions 10, 11 were expanded respectively, and they were brought in contact with each other at adjoining portions (FIGS. 4C and 4D). When the Z stage 8 was further moved downwardly as it was at a velocity of 0.01 mm per second, an adhesive interposing area 13, in which the inter-adhesive puddle combined portions 10, 11 were integrated into one, was expanded so that the voids 12 were extruded to the outside (FIGS. 4E and 4F). Further, when the Z stage 8 was moved downwardly at a velocity of 0.05 mm per second, then the lifting pins 7 were sufficiently lowered, and the lifting pins 7 were separated from the first substrate 1. The adhesive interposing area 13 was pressed by the self-weight of the first substrate 1, and thus the adhesive interposing area 13 was entirely spread or expanded between the first and second substrates 1, 2 without generating any bubble. The space between the first and second substrates 1, 2 was filled with the adhesive. The thickness of the adhesive was about 0.12 mm.

Finally, the adhesive overflowed from the second substrate 2 was wiped out, and the adhesive was cured by radiating the ultraviolet light. In this way, the first substrate 1 and the second substrate 2 were successfully adhered to one another by means of the adhesive.

Ten samples were manufactured for the respective substrate sizes respectively, wherein no problem arose in all of them in relation to the remaining of the bubble. Results are shown in Table 1. As for the evaluation, the number of samples with remaining bubbles per the number of all samples is shown as the bubble remaining ratio.

### Comparative Example 1

Three types of substrate sizes, which were the same as those in Example 1, were used. As shown in FIGS. 5A and 5B, 0.05 ml of the adhesive was applied to one central portion on the first substrate 1 to form one adhesive puddle 3 in relation to all of the substrate sizes. Other than the above, samples were manufactured in accordance with exactly the same method as that of Example 1.

When the first substrate 1 and the second substrate 2 were attached to the apparatus shown in FIG. 2 in the same manner as in Example 1, and the spacing distance between the both was progressively narrowed (FIGS. 5C and 5D), then the adhesive puddle 3 and the adhesive puddle 4 were brought in contact with each other to form an inter-adhesive puddle combined portion 10 (FIGS. 5E and 5F). In this situation, the adhesive puddles 3, 4 were brought in contact with each other, and thus the adhesive puddle 4 was attracted toward the first substrate 1 in accordance with the surface tension. The inter-adhesive puddle combined portion 10 was expanded, simultaneously with which a recess 15′ was generated on the adhesive puddle 4 disposed therearound.

When the spacing distance between the first and second substrates 1, 2 is further narrowed progressively, then the inter-adhesive puddle combined portion 10 was expanded, and the adhesive puddle 4 was brought in contact with the first substrate 1 at the outside of the recess 15′ generated on the adhesive puddle 4 to form adhesive contacting sticking portions 14 (FIGS. 6A and 6B). As the spacing distance between the first and second substrates 1, 2 is further narrowed, the adhesive contacting sticking portions 14 were expanded. The adjoining adhesive contacting sticking portions 14 were brought in contact with each other and they were integrated into one which was further expanded (FIGS. 6C and 6D). Finally, the adhesive contacting sticking portions 14 were brought in contact with the firstly formed inter-adhesive puddle combined portion 10, and they were integrated into one. However, in this situation, the bubbles 15 remained (FIGS. 6E and 6F). Even when the integrated adhesive interposing area 16 was entirely expanded or spread between the first and second substrates 1, 2, the bubbles 15 remained as they were.

Ten samples were manufactured for the respective substrate sizes respectively, wherein the problem, in which the bubbles remained, arose in those having the substrate sizes of not less than 13 inches. The frequency of the occurrence of bubbles was more increased as the substrate size was larger. The problem, in which the bubbles remained, arose in all of the ten samples in the case of the 30 inches and the 50 inches. Results are shown in Table 1 in the same manner as in Example 1.

TABLE 1
Bubble remaining ratio

| | Substrate size | | |
|---|---|---|---|
| | 13 inches | 30 inches | 50 inches |
| Example 1 | 0% | 0% | 0% |
| Comp. Ex. 1 | 20% | 100% | 100% |

### Comparative Example 2

Ten samples were manufactured in accordance with exactly the same method as that of Example 1 except that the substrate size of 5 inches was used, 1 ml of the adhesive was applied to one central portion on the first substrate 1, and one adhesive puddle 3 was formed. As a result, the problem, in which the bubbles remained at the central portion of the sample, arose in the two samples in the same manner as in Comparative Example 1.

### Example 2

A black light shielding member having a plurality of openings in a matrix form, a fluorescent substance positioned in each of the openings, and an anode electrode for covering surfaces of the light shielding member and the fluorescent substance were formed on one surface of a soda lime plate glass of 50 inches having a thickness of 2.5 mm and an aspect ratio of 1.25 to prepare a face plate. Further, a plurality of raw direction wiring lines, a plurality of column direction wiring lines, a plurality of electron emission elements of the field emission type connected to the wiring lines, and a plurality of spacers were formed on one surface of a soda lime plate glass having the same size as that of the above to prepare a rear plate. A frame composed of glass was attached to the circumference of the one surface of the rear plate described above, and a frit glass was arranged on the frame. The frit glass was heated and melted in a vacuum atmosphere at 10⁻⁶ Pa in a state in which the rear plate and the face plate were held so that the fluorescent substance and the electron emission elements were opposed to one another. The face plate and the frame were joined to one another to manufacture a display body having a thickness of 8.0 mm.

Subsequently, a light-transmissive resin film was stuck or laminated to the display surface side of the display body in order to suppress the electrification. The light-transmissive resin film was a PET film having a coating layer of polyester resin (PET) dispersed with ITO particles. The light-transmissive resin film had a size approximately equivalent to that of a display substrate for constructing a display surface of the display body 18. The PET film was stuck with an acrylic adhesive onto the side of the display surface of the display body. In Example 2, the display substrate is composed of the soda lime plate glass for constructing the face plate and the light-transmissive resin film to suppress the electrification, and the outer surface disposed on the display surface of the display body 18 resides in the coating layer of PET dispersed with ITO particles.

Further, a soda lime plate glass was prepared, which had the same size as that of the face plate except that the size was diagonally larger by 10 mm than that of the face plate of the display body. A light-transmissive resin film was stuck to one surface of the soda lime plate glass in order to suppress the light reflection. The light-transmissive resin film had an acrylic resin layer dispersed with silica fine particles on a surface of PET film. The size was approximately equivalent to that of the soda lime plate glass to be stuck. The PET film was stuck to one surface of the soda lime plate glass with an acrylic adhesive. In Example 2, the light-transmissive substrate is composed of the glass and the light-transmissive resin film to suppress the light reflection. The adhering surface of the light-transmissive substrate is the glass surface described above.

The display body was used as the second substrate and the light-transmissive substrate was used as the first substrate in the same manner as in the adhesion of the first substrate and the second substrate of 50 inches in Example 1. The glass surface of the light-transmissive substrate was adhered to the coating layer surface of PET as the display surface of the display body.

A display was manufactured by attaching a driving circuit for the display operation to the display body manufactured as described above. The problem, in which the bubbles remained, did not arose in Example 2 as well in the same manner as in Example 1.

### Example 3

A display body of 50 inches and a light-transmissive substrate, which were constructed in the same manner as in Example 2 except that the aspect ratio was 1.75, were used for the first substrate 1 and the second substrate 2.

As for the adhesive to be formed on the first substrate 1, 0.05 ml of the adhesive was used for one portion, and the adhesive was applied by the dropping. The number of adhesive puddles 3 to be formed thereby differed depending on the number of those dropped on the second substrate 2. In Example 3, as shown in FIG. 7A, the adhesive puddles 3 were formed at thirty-nine portions in total, wherein the adhesive puddles 3 were formed at a central portion and two left and right portions thereof, i.e., at three portions in each of areas of the first substrate 1 which were opposed to positions at which the adhesive puddles 4 were formed on the second substrate 2. The respective adhesive puddles 3 subjected to the dropping were applied at positions at intervals or spacing distances of 40 mm on a straight line passing through the centers of the opposing adhesive puddles 4.

As shown in FIG. 7B, the adhesive, which was to be applied onto the second substrate 2, was applied at two portions on two points of intersection at which bisectors of interior angles of respective corners of the second substrate 2 and a straight line for connecting centers of both short sides intersected and at three portions which were disposed at equal intervals on a line for connecting the two points of intersection. Additionally, the adhesive was applied at eight portions in total, wherein the adhesive was applied at two portions on each of line segments of the respective bisectors ranging from the corners to the points of intersection. When the two portions and the three portions were added up, the thirteen adhesive puddles 4 were formed in total.

In Example 3, the total amount of the adhesive was 260 ml. At first, about 42% of the total amount was applied while being divided into those for the two portions to form the adhesive puddles 4 at the points of intersection at which the bisectors of the interior angles of the respective corners of the second substrate 2 and the straight line for connecting the centers of the both short sides intersected. In this procedure, the amount per one portion was 55 ml. Similarly, about 45% of the total amount was applied to the three portions obtained by equally dividing the distance between the points of intersection into four at equal intervals on the straight line for connecting the two points of intersection. In this procedure, the amount of application per one portion was 38 ml. The remaining amount of about 13% was divided into four for the four line segments of the respective bisectors ranging from the corners to the points of intersection, and then the adhesive was applied to the two portions at equal intervals on each of the line segments. In this procedure, the amounts, each of which was subjected to the dropping onto one line segment, were 6 ml and 3 ml as referred to in an order starting from one disposed nearer to the point of intersection.

Assuming that the length of the short side of the second substrate 2 is A and the length of the long side is B, the dropping amount, which is required to charge the adhesive until arrival at the same size as that of the second substrate 2, is larger than at least “A×B×desired adhesive thickness”. It is assumed that Sc represents the total amount subjected to the dropping onto the straight line (including the points of intersection) for connecting the two points of intersection at which the bisectors of the interior angles of the respective corners of the second substrate 2 and the straight line for connecting the centers of the both short sides intersect, and Sr represents the total amount subjected to the dropping onto the line segments of the respective bisectors ranging from the corners to the points of intersection. On this assumption, the ratio between Sc and Sr is expressed as follows, for example, while being classified into the following two cases.

For the purpose of simplification, it is assumed that there are given S1=(π/4)×A2, S2=A(B−A).

(i) In the case of A=B:

$$\begin{matrix}Sc \text{:} Sr = S 1 \text{:} \{ A 2 - S 1 \} \\ = ( π / 4 ) \times A 2 \text{:} \{ A 2 - ( π / 4 ) \times A 2 \} \\ = π \text{:} ( 4 - π )\end{matrix}$$

(ii) In the case of A≠B:

Sc:Sr=S1+S2:{AB−(S1+S2)}

In Example 3, the aspect ratio is 1.75 for 50 inches. Therefore, the following criterion is given when the calculation is performed by using (ii):

Sc:Sr=0.87:0.13

Therefore, it is determined to use Sc=224 ml, Sr=36 ml of the total dropping amount of 260 ml.

The adhesion was performed in the same manner as the adhesion of the display body and the light-transmissive substrate in Example 2. The thickness of the adhesive was about 0.38 ml, and the extruding amount was 5 ml which was 1.5%. When the adhesive is applied as in Example 3, it is possible to expect such an effect that the extruding amount is decreased after the sticking or lamination. The problem, in which the bubbles remained, did not arose in the same manner as in Examples 1 and 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-269584, filed on Nov. 27, 2009, and Japanese Patent Application No. 2010-186989, filed on Aug. 24, 2010, which are hereby incorporated by reference herein in their entirety.

What is claimed is:

1. A method for producing a display comprising a display body and a light-transmissive substrate adhered to an outer surface disposed on a display surface of the display body, the method comprising the steps of:
applying an adhesive to the outer surface disposed on the display surface of the display body to form an adhesive puddle or adhesive puddles on the outer surface disposed on the display surface of the display body;
applying the adhesive to one surface of the light-transmissive substrate to form adhesive puddles on the light-transmissive substrate;
arranging the display body and the light-transmissive substrate while allowing the surface of the light-transmissive substrate formed with the adhesive puddles to be directed downwardly so that the adhesive puddles, which are formed on the light-transmissive substrate, are opposed to the adhesive puddle or adhesive puddles which is/are formed on the outer surface disposed on the display surface of the display body; and
allowing the display body and the light-transmissive substrate to approach to one another so that a space between the light-transmissive substrate and the outer surface disposed on the display surface of the display body is filled with the adhesive applied to the light-transmissive substrate and the outer surface disposed on the display surface of the display body, wherein
a plurality of the adhesive puddles are formed on the light-transmissive substrate in an area which is disposed on the light-transmissive substrate and which is opposed to the adhesive puddle formed on the outer surface disposed on the display surface of the display body.

2. A method for adhering light-transmissive substrates, comprising the steps of:
applying an adhesive to a first light-transmissive substrate to form adhesive puddles on the first light-transmissive substrate;
applying the adhesive to a second light-transmissive substrate to form an adhesive puddle or adhesive puddles on the second light-transmissive substrate;
arranging the first light-transmissive substrate and the second light-transmissive substrate while allowing a surface of the first light-transmissive substrate formed with the adhesive puddles to be directed downwardly so that the adhesive puddles, which are formed on the first light-transmissive substrate, are opposed to the adhesive puddle or adhesive puddles which is/are formed on the second light-transmissive substrate; and
allowing the first light-transmissive substrate and the second light-transmissive substrate to approach to one another so that a space between the first light-transmissive substrate and the second light-transmissive substrate is filled with the adhesive applied to the first light-transmissive substrate and the second light-transmissive substrate, wherein
a plurality of the adhesive puddles are formed on the first light-transmissive substrate in an area which is disposed on the first light-transmissive substrate and which is opposed to the adhesive puddle formed on the second light-transmissive substrate.
